(19) United States
(12) Patent Application Publication
(10) Pub. No.: US 2015/0266759 A1
(43) Pub. Date: Sep. 24, 2015

(54) WASTEWATER TREATMENT APPARATUS WITH DUAL-LEVEL CONTROL

(71) Applicant: Parkson Corporation, Fort Lauderdale, FL (US)

(72) Inventor: Charles R. MORGAN, Fort Lauderdale, FL (US)

(73) Assignee: PARKSON CORPORATION, Fort Lauderdale, FL (US)

(21) Appl. No.: 14/663,274

(22) Filed: Mar. 19, 2015

Related U.S. Application Data
(60) Provisional application No. 61/968,733, filed on Mar. 21, 2014.

(51) Int. Cl. C02F 3/00; C02F 3/30

(52) U.S. Cl. CPC C02F 3/006; C02F 3/302; C02F 2209/22; C02F 2209/14; C02F 2209/15; C02F 2209/07; C02F 2209/04

(57) ABSTRACT

A dual-level control system for operating a wastewater treatment apparatus may include at least a primary level of control including a measurement of a process control variable to arrive at a dissolved oxygen (DO) set point and a primary mode of operating parameters including primary aeration chain timer and primary aeration chain grouping designed to achieve the DO set point when the DO set point falls within a predetermined range of values; and at least a secondary level of control to arrive at a secondary mode of operating parameters including secondary aeration chain timer and secondary aeration chain grouping designed to achieve a desired concentration of effluent total nitrogen when the DO set point either falls to or below a minimum value or rises to or above a maximum value. The process control variable may be, for example, an effluent concentration of NH₃, NO₃, alkalinity, ORP, or a combination thereof.

### CROSS-REFERENCE TO RELATED APPLICATIONS

This application claims priority to and the benefit of U.S. Provisional Patent Application No. 61/968,733, which was filed on Mar. 21, 2015, and which is incorporated herein by reference in its entirety.

### BACKGROUND

Biological nitrogen removal from wastewater is a sequential, two-step process that has different process environments for each step. The first step, nitrification, oxidizes ammonia (NH₃) nitrogen either to nitrite (NO₂) or nitrate (NO₃), and is an aerobic process that takes place in the presence of free oxygen (oxic conditions). The second step, denitrification, reduces nitrite or nitrate to nitrogen (N₂) gas, and is a process that takes place in the absence of free oxygen (anoxic conditions).

The removal of nitrogen biologically from wastewater requires the proper balance and control of these two environments to maximize nitrogen removal efficiency. The biological nitrogen removal process is well documented in literature as are many different process configurations for achieving it. Wastewater treatment plant designers strive to accomplish the required total nitrogen removal in a robust, yet simple process that is easy to operate, while using the least possible amount of energy.

### SUMMARY

According to one embodiment of the present invention, a dual-level control system for operating a wastewater treatment apparatus may comprise: at least a primary level of control including a measurement of process control variable to arrive at a dissolved oxygen (DO) set point and a primary mode of operating parameters including primary aeration chain timer and primary aeration chain grouping designed to achieve the DO set point when the DO set point falls within a predetermined range of values; and at least a secondary level of control to arrive at a secondary mode of operating parameters including secondary aeration chain timer and secondary aeration chain grouping designed to achieve a desired concentration of effluent total nitrogen when the DO set point either falls to or below a minimum value or rises to or above a maximum value. The process control variable may be, for example, a concentration of effluent ammonia (NH₃), a concentration of effluent nitrate (NO₃), a concentration of effluent alkalinity, a concentration of effluent oxidation-reduction potential (ORP), or a combination thereof.

According to another embodiment of the present invention, a wastewater treatment apparatus may comprise one or more treatment basins, each configured to accept influent and to release effluent and equipped with a plurality of aeration chains, one or more aeration blowers, one or more sensors to measure dissolved oxygen (DO) in the basin, one or more sensors to measure at least one process control variable and one or more control features for automatically adjusting DO set point, aeration chain timer and aeration chain grouping. The at least one process control variable may be, for example, a concentration of effluent ammonia (NH₃), a concentration of effluent nitrate (NO₃), a concentration of effluent alkalinity, a concentration of effluent oxidation-reduction potential (ORP), or a combination thereof.

According to another embodiment of the present invention, a method of automatically operating a biological wastewater treatment process within one or more treatment basins, each equipped with a plurality of aeration chains, may comprise: automatically measuring a process control variable, automatically comparing the measured process control variable with a predetermined value, automatically adjusting a dissolved oxygen (DO) set point based on a deviation, if any, of the measured process control variable from the predetermined value and automatically adjusting an aeration chain timer and/or an aeration chain grouping based on a deviation, if any, of the measured process control variable from the predetermined value. The process control variable may be, for example, a concentration of effluent ammonia (NH₃), a concentration of effluent nitrate (NO₃), a concentration of effluent alkalinity, a concentration of effluent oxidation-reduction potential (ORP), or a combination thereof.

It is to be understood that both the foregoing general description and the following detailed descriptions are exemplary and explanatory only, and are not restrictive of the invention as claimed.

### BRIEF DESCRIPTION OF THE DRAWINGS

The features, aspects, and advantages of the present invention will become apparent from the description, appended claims, and the accompanying exemplary embodiments shown in the drawings, which are briefly described below.

FIG. 1 shows a schematic view of a wastewater treatment process according to a first configuration.

FIG. 2 shows a schematic view of a wastewater treatment process according to a second configuration.

FIG. 3A shows one individual aerator in an aeration chain according to one embodiment of the present invention

FIGS. 3B and 3C show one individual aerator in an aeration chain according to another embodiment of the present invention.

FIG. 4A shows a top view of the treatment basin with the plurality of aeration chains of FIG. 3A.

FIG. 4B shows a top view of the treatment basin with the plurality of aeration chains of FIGS. 3B and 3C.

FIG. 5 shows a process of operating a biological wastewater treatment process using a dual-level control system.

FIG. 6 shows a table providing an example of the various types of operation modes that may be available for the dual-level control system.

FIG. 7 shows a table providing a comparison of the changes in the DO set point depending on the values of certain process control variables.

### DETAILED DESCRIPTION

Various embodiments of the present invention will be explained with reference to the accompanying drawings.

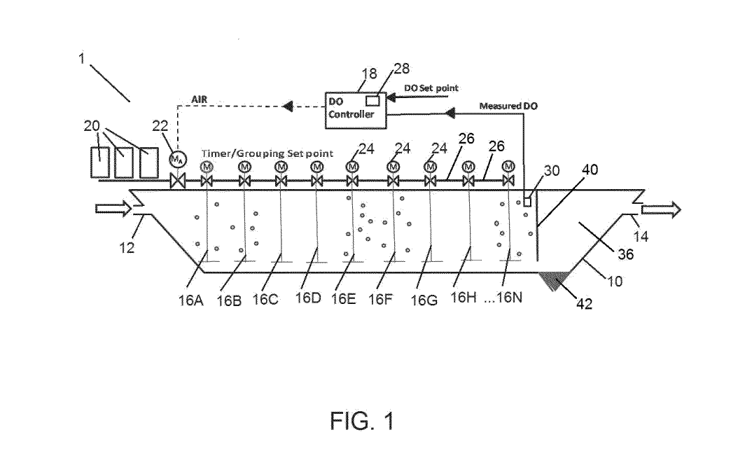

FIG. 1 shows a schematic view of a wastewater process and system 1 used to provide total nitrogen removal from wastewater according to a first configuration. This wastewater treatment process and system 1 may include a treatment basin 10 with an inlet 12 for influent and an outlet 14 for effluent, one or more aerations chains 16A-16N for permitting gas flow into the treatment basin 10, a controller 18, one or more blowers 20, a blower output control device such as a first control valve 22, and a plurality of second control valves 24. The blowers 20, the first control valve 22, and the plurality of second control valves 24 are connected through a series of connection lines 26, which may be tubes, pipes, fluid channels, vents, and/or any other suitable fluid channeling element. The blower output control device such as the first control valve 22 controls the amount of air passing from the blowers 20 to the plurality of second control valves 24 based on one or more commands from the controller 18. Of course, the blower output control device may be any device known in the art that may control the blower output. Two separate control loops run by the controller 18 are used to adjust the process environment within the one treatment basin 10 to provide the required oxic and anoxic conditions to enable the removal of nitrogen from the wastewater. This single basin approach has advantages over more traditional multi-basin nitrogen removal processes known in the art. The controller 18 may include a programmable logic controller (PLC) and a DO analyzer. The PLC actually takes the DO signal from the DO analyzer, compares the DO signal to the DO set point and adjusts the aeration system according to the PLC program contained in the PLC. The PLC and the DO analyzer may be in a single housing or in separate housings and/or be on the same circuit board or different circuit boards.

Additionally, a clarifier 36 is placed near the outlet 14 of the treatment basin 10. The clarifier is separated from the aeration chains by a separating wall 40. After being subjected to the aeration chains 16A-16N, the fluid then goes under the separating wall 40 before flowing upward to the outlet 14. The heavier impurities sink by gravity toward the draining outlet 42. The impurities can then be further treated and/or disposed of after exiting through the draining outlet 42.

The first control loop is manually adjusted and controls the operation of the aeration chains 16A-16N within the treatment basin 10. Several adjacent aeration chains are operated as a group, with at least two groups defined within the one basin 10. A first group (for example, chains 16A-16D) is operated with the air ON, creating an oxic zone in the basin 10 at the locations where a member(s) of the first group operates while a second group (for example, chains 16E-16H) is operated with the air OFF, creating an anoxic zone at the locations where a member(s) of the second group operates. A timer 28 in the controller 18 may be used to alternate the operation of the groups so that each zone to which each member of the groups are assigned may go from oxic to anoxic to oxic, etc. This operation may result in there always being some oxic and some anoxic zones within the one treatment basin 10.

Adjustments to the aeration chain groups themselves (i.e. number and location of aeration chains in a group) are done manually, as is any adjustment to the timing sequence of their operation. Manual adjustments require operator time and attention. In addition, manual adjustments are made based on historical information and in no way reflect the operating conditions that might be experienced in the future. Therefore, manually adjusting the system 1 is an ongoing attempt to optimize the operation of the aeration chains 16A-16N that is always and necessarily based on historical knowledge. It is not dynamic or real-time based.

The second control loop requires manual input of the dissolved oxygen (DO) set point, which the controller 18 then compares to the actual dissolved oxygen concentration in the treatment basin 10 from the DO sensor 30, and determines if an increase or decrease in the rate of oxygen supply to the treatment basin 10 is required to achieve the desired set point. The increase or decrease in the rate of oxygen supply to the treatment basin is accomplished by the controller 18 issuing a command to the blower output control device such as the first control valve 22 that permits air flow from the one or more blowers 20 to the plurality of second control valves 24. Maintaining the DO within a defined range allows sufficient oxic and anoxic conditions to develop within the treatment zones, thereby ensuring efficient nitrogen removal. However, achieving the desired DO set point is only part of the control process, as the end goal of the treatment process is nitrogen removal, not DO control. Experience has shown that as the influent load varies to the treatment basin 10, the same DO set point does not always produce the same nitrogen removal efficiency. Therefore, the DO set point should be adjusted as the pollutant load or flow to the treatment basin 10 varies. This DO set point adjustment is done manually based on the concentration of the various forms of nitrogen in the effluent at the outlet 14. These concentrations are determined by manually sampling the effluent at the outlet 14 and manually testing these samples in a lab. This sampling and testing takes time, which delays the receipt of process information. This sampling and testing then delays the process control response time by hours or even days from the time the sample is taken until the time the process is actually adjusted. During this delay, the process may not be adjusted to provide the optimum level of nitrogen removal, and it may not be adjusted to remove nitrogen using the least amount of energy. Therefore, this manual approach to process control reduces the average effluent quality and increases operating costs by not having the ability to instantaneously make these process adjustments.

The approach of FIG. 1 has proven to be successful in promoting biological nitrification and denitrification to produce an effluent total nitrogen concentration of less than 8 mg/l, including an effluent concentration of effluent NH₃ of less than 1 mg/l. While the process and system of FIG. 1 offers some flexibility to adjust to changing process conditions, it is limited in that several adjustments must be made manually.

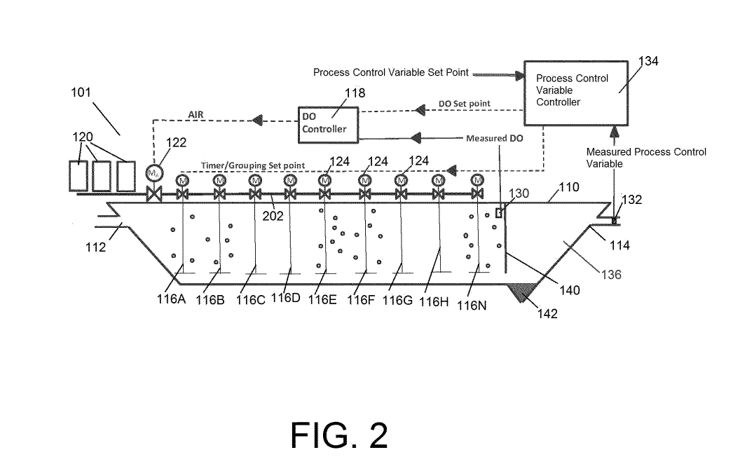

FIG. 2 shows a schematic view of a wastewater process and system 101 according to a second configuration used to provide total nitrogen removal from wastewater. The total nitrogen (N) concentration is the sum of the concentrations of ammonia nitrogen (NH₃), organic nitrogen, nitrate nitrogen (NO₃), and nitrite nitrogen (NO₂). Achieving a low total N effluent concentration involves the removal of all these constituents to the highest possible extent. Nitrite is typically an unstable form of nitrogen which rapidly resolves to NO₃. A substantial portion of the organic nitrogen will be transformed to NH₃ within the biological process, but there is typically a small residual amount of more complex organic nitrogen compounds which do not break down and remain in the effluent. The biological wastewater process removes NH₃ through biological nitrification and the resulting nitrate through biological denitrification. Measuring effluent ammonia (NH₃) or effluent (NO₃) concentration may indicate directly if the biological process is in proper balance for total nitrogen removal, or if an adjustment needs to be made. In the same way, effluent alkalinity and effluent ORP may also change with the process conditions, and may indirectly indicate if the biological process is in proper balance for total nitrogen removal, or if an adjustment needs to be made. Therefore, any of these parameters (effluent NH₃, effluent NO₃, effluent alkalinity, and/or effluent ORP) can be used for process control to optimize total nitrogen removal. The expectation is that the direct indicators (effluent NH₃ and effluent NO₃) may be superior process control parameters versus the indirect parameters (alkalinity and effluent ORP), and that NH₃ may be the most reliable process control parameter to use since biological nitrification is the rate limiting reaction.

The wastewater treatment system or apparatus 101 may comprise one or more treatment basins 110, each configured to accept influent via one or more inlets 112 and to release effluent via one or more outlets 114. The one or more treatment basins 110 may be equipped with a plurality of aeration chains 116A-116N, one or more aeration blowers 120, one or more sensors 130 to measure dissolved oxygen (DO) in the basin 110, one or more sensors 132 to measure a process control variable and one or more control features for automatically adjusting the DO set point, the aeration chain timer and the aeration chain grouping. The one or more treatment basins may or may not be equipped with a sensor to measure a concentration of effluent nitrate (NO₃), preferably not so equipped. Additionally, a clarifier 136 is placed near the outlet 114 of the treatment basin 110. The clarifier is separated from the aeration chains by a separating wall 140. After being subjected to the aeration chains 116A-116N, the fluid then goes under the separating wall 140 before flowing upward to the outlet 114. The heavier solids sink by gravity toward the draining outlet 142. The settled material can then be further treated and/or disposed of after exiting through the draining outlet 142.

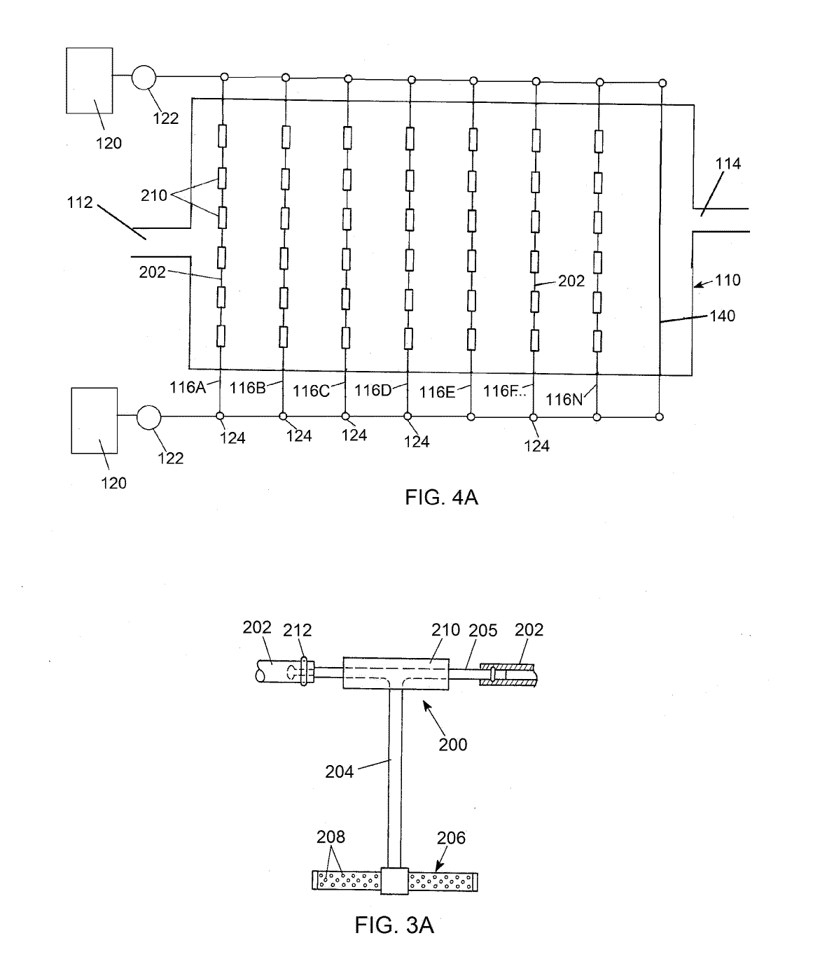

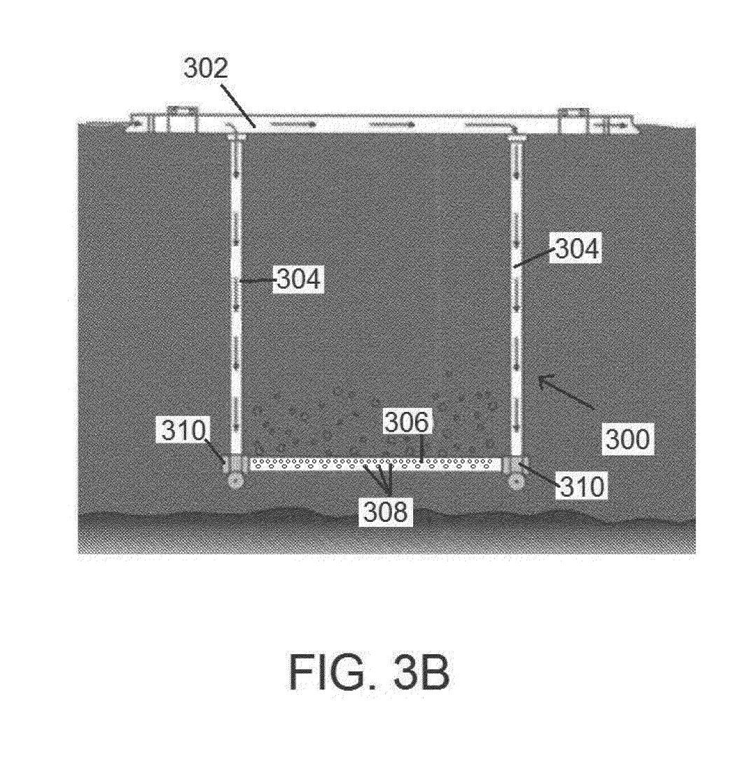

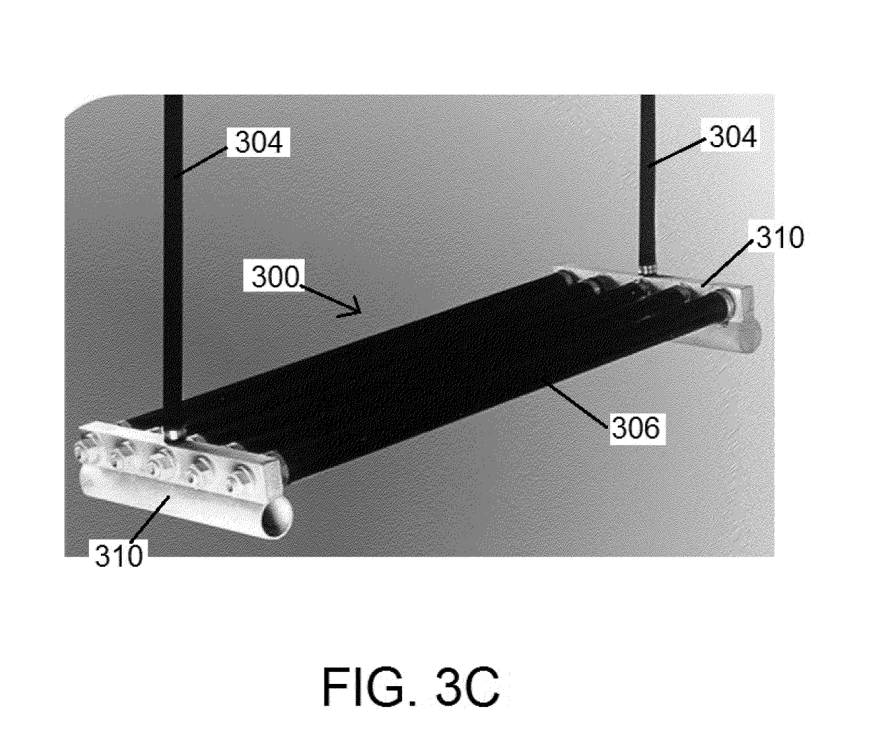

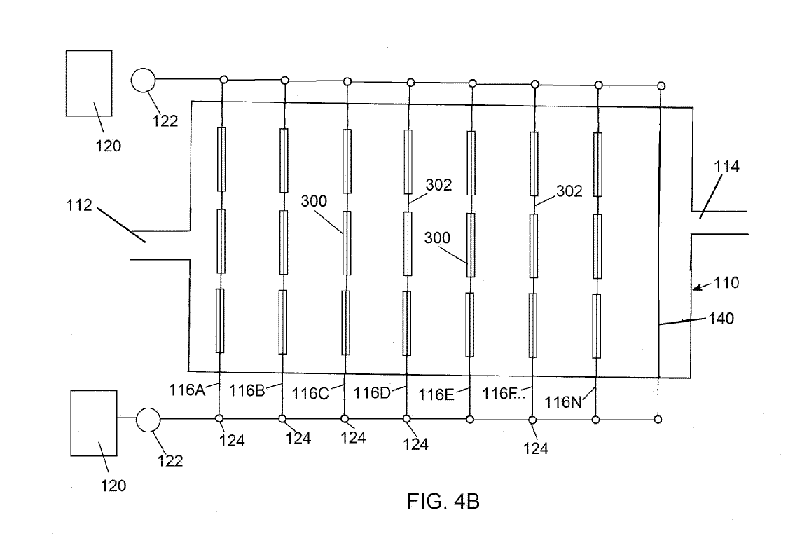

The aeration chains 116A-116N are stretched over the treatment basin 10 or 110 in the configurations shown in FIGS. 1 and 2. FIG. 3A shows one individual aerator 200 in an aeration chain 116A for the purposes of illustration. FIG. 4A shows a top view of the treatment basin 110 with the plurality of aeration chains 116A-116N. In a broad sense, an aeration chain may be, for example, an aeration device employed in at least one wastewater treatment basin having an inlet and an outlet, with a plurality of bottom aerators either suspended adjacent to one another from a carrier, or resting on the basin bottom adjacent to one another, and supplied by an aeration blower via an air supply conduit for introducing air into the sewage through the bottom aerators. The suspended bottom aerators may or may not be disposed for reciprocating movement in the basin depending on the design and installation details of the aeration chain design.

Referring back to FIG. 4A, the aeration chains 116A-116N are stretched over the treatment basin 110, each chain carrying individual spaced-apart bottom aerators 200. In a broad sense, a bottom aerator may be, for example, an aeration device located in proximity to the basin bottom, designed to introduce air or oxygen into a wastewater treatment basin such that the air is broken into small bubbles to enhance the transfer of oxygen from the gas phase into the liquid phase. The individual aerator may be connected to the aeration chain by an air supply line 202. As seen in FIG. 3A, the connection with the aerators 200 is provided by at least one vertical connecting pipe 204 from a horizontal upper section 205. The two opposite ends of the section 205 are inserted into the two hose ends of two adjacent sections of the air supply line 202. A distribution pipe 206 is fastened at lower end of the connecting pipe 204 and runs substantially parallel to the horizontal section 205, the distribution pipe 206 containing numerous air openings 208 on its periphery. Through the air supply line 202 and the connecting pipe 204, the distribution pipe 206 can be supplied with compressed air from the one or more blowers 120 after passing through the blower output control device (such as, for example, the first control valve 122), which then flows out through the air openings 208. A float 210 may optionally be provided in the region above each aerators 200, may extend substantially parallel to the longitudinal axis of the distribution pipe 206, and may ensure the floating support of the bottom aerators 200. The connections between the hoses and the bottom aerator 200 are held together with conventional fasteners, such as, for example, with clamping brackets 212, sealing adhesive, etc. For more details of the aeration chain, see U.S. Pat. No. 4,797,212, which is incorporated by reference in its entirety. According to other embodiments, flexible lines may be used instead of rigid pipes and/or rigid pipes may be used instead of flexible lines.

FIGS. 3B and 3C shows one individual aerator 300 in an aeration chain 116A according to another embodiment of the present invention. FIG. 4B shows a top view of the treatment basin 110 with the plurality of aeration chains 116A-116N.

The aeration chains 116A-116N are stretched over the treatment basin 110, each chain carrying individual spaced-apart bottom aerators 300. The individual aerator may be connected to the aeration chain by an air supply line 302. The connection with the aerators 300 is provided by at least two vertical connecting pipes 304 connected to the air supply line 302. At least one distribution pipe 306 is fastened at the lower ends of the connecting pipes 304 and runs substantially parallel to the air supply line 302, the at least one distribution pipe 306 containing numerous air openings 308 on its periphery. The at least one distribution pipe 306 is connected to the connecting pipes 304 through a manifold 310 at either end of the at least one distribution pipe 306. Further, the at least one distribution pipe 306 may be any suitable number of pipes such as, for example, 1, 2, 5, 10, 20, or more or any integer therebetween. Through the air supply line 302 and the connecting pipes 304, the at least one distribution pipe 306 can be supplied with compressed air from the one or more blowers 120 after passing through the blower output control device (such as, for example, the first control valve 122), which then flows out through the air openings 308. The air supply line 302 may be a floating pipe that ensures the floating support of the bottom aerators 300. Alternatively, a float may optionally be provided in the region above each aerators 300, may extend substantially parallel to the longitudinal axis of the distribution pipe 306, and may ensure the floating support of the bottom aerators 300. The connections between the air supply line 302 and the bottom aerator 300 are held together with conventional fasteners, such as, for example, with clamping brackets, sealing adhesive, welding, soldering, etc. The air supply lines 302, the connecting pipes 304, and the distribution pipes 306 may be flexible lines, rigid pipes, or any combination thereof.

Also, according to other embodiments of the present invention, the aeration chain and aerators may be one or more of tubes, pipes, fluid channels, vents, and/or any other suitable fluid channeling element in any combination that permits pressurized air to flow therethrough and emerge through openings so as to allow the escape of the pressurized air outside the fluid channeling element.

With regard to the aeration blowers 120, such an aeration blower may be a device that compresses atmospheric air to a higher pressure, so that the air can be introduced into the wastewater treatment basin through the bottom aerators.

The blower output control device such as the first control valve 122 controls the amount of air passing from the blowers 120 to the plurality of second control valves 124 based on one or more commands from the controller 118. The controller 118 adjusts the process environment within the one or more treatment basins 110 to provide the required oxic and anoxic conditions to enable the removal of nitrogen from the wastewater.

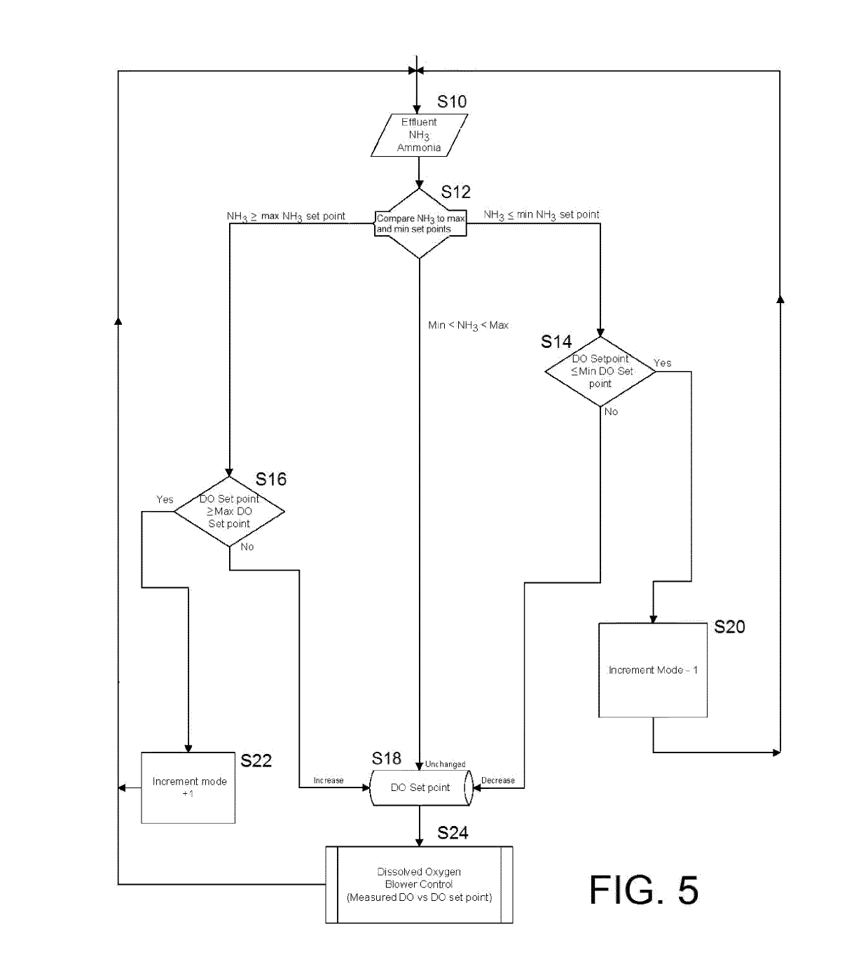

The one or more control features for automatically adjusting the DO set point, the aeration chain timer and the aeration chain grouping may be carried out by one or more controllers. In a broad sense, an aeration chain timer may be a timer used to control the cycling of air flow to an aeration chain, according to a set program as determined by the aeration system controller(s) while an aeration chain grouping may be a predetermined arrangement of adjacent aeration chains, from, for example, a quantity of one to 20 aeration chains, that are controlled together as one entity by the aeration system controller(s). The control features may be embodied by the DO controller 118, the process control variable controller 134, and/or a combination thereof. The DO controller 118 and the process control variable controller 134 carry out the processes of FIG. 5, and each may be constituted by a microcomputer comprising a central processing unit (CPU), a read-only memory (ROM), a random access memory (RAM), an input/output interface (I/O interface), a counter, and one or more timers. Alternatively or additionally, each of the DO and process control variable controllers may be constituted by a plurality of microcomputers. Each of the DO and process control variable controllers may comprise the necessary hardware and/or software to carry out its functions disclosed herein. For example, the software may be stored on a tangible memory device, such as a DVD or a CD-ROM, which is accessible by the DO and process control variable controllers. Furthermore, the DO controller 118 and the process control variable controller 134 may be both housed within a single controller housing on the same or different circuit boards, or may be both housed in multiple controller housings. Further, the DO controller 118 may include a programmable logic controller (PLC) and a DO analyzer. The PLC actually takes the DO signal from the DO analyzer, compares the DO signal to the DO set point and adjusts the aeration system according to the PLC program contained in the PLC. The PLC, the process control variable controller 134, and the DO analyzer may be in a single housing or in separate housings and/or on the same or different circuit boards. According to one embodiment of the present invention, the PLC performs the process control in which it receives 4-20 ma signals from the DO and process control variable sensors/analyzers and uses these signals to control the process according to the program and set points established in the PLC. For sake of simplicity, the controller(s) used in the system and during the process will be collectively referred to as the “process control variable controller/PLC.”

The one or more control features embody a dual-level control system for operating the wastewater treatment apparatus or system 101. The dual-level control system may comprise at least a primary level of control and at least a secondary level of control. The at least a primary level of control may include a measurement of a process control variable using a process control variable sensor 132 at the outlet 114 of the treatment basin 110 so as to arrive at a dissolved oxygen (DO) set point using the process control variable controller 134. The process control variable that the sensor 132 measures may be effluent ammonia (NH₃), effluent nitrate (NO₃), effluent alkalinity, or effluent oxidation-reduction potential (ORP). The description below uses effluent ammonia (NH₃) as the process control variable for the purposes of illustration.

The at least a primary level of control may also include a primary mode of operating parameters by the process control variable controller/PLC. The primary mode of operating parameters may include a primary aeration chain timer and a primary aeration chain grouping designed to achieve the DO set point determined by the process control variable controller/PLC when the DO set point falls within a predetermined range of values.

According to one embodiment, a measurement of a concentration of effluent NH₃ by the process control variable sensor 132, which falls within a predetermined range of values, allows the wastewater treatment apparatus to maintain a primary mode of operating parameters to be operated by the process control variable controller/PLC. However, a measurement of a concentration of effluent NH₃ by the process control variable sensor 132, which is at or below a minimum value, calls for a decrease in a DO set point as determined by the process control variable controller/PLC. A measurement of a concentration of effluent NH₃ by the process control variable sensor 132, which is at or above a maximum value, calls for an increase in a DO set point as determined by the process control variable controller/PLC. A decrease in a DO set point signals a decrease in an output of one or more aeration blowers 120 as commanded by the process control variable controller/PLC, while an increase in a DO set point signals an increase in an output of the one or more aeration blowers 120 as commanded by the process control variable controller/PLC.

The at least a secondary level of control arrives at a secondary mode of operating parameters by the process control variable controller/PLC. The secondary mode of operating parameters may include a secondary aeration chain timer and a secondary aeration chain grouping designed to achieve a desired concentration of effluent total nitrogen when the DO set point either falls to or below a minimum value or rises to or above a maximum value.

According to one embodiment, the at least primary level of control and the at least secondary level of control do not rely on a measurement of a concentration of effluent nitrate (NO₃).

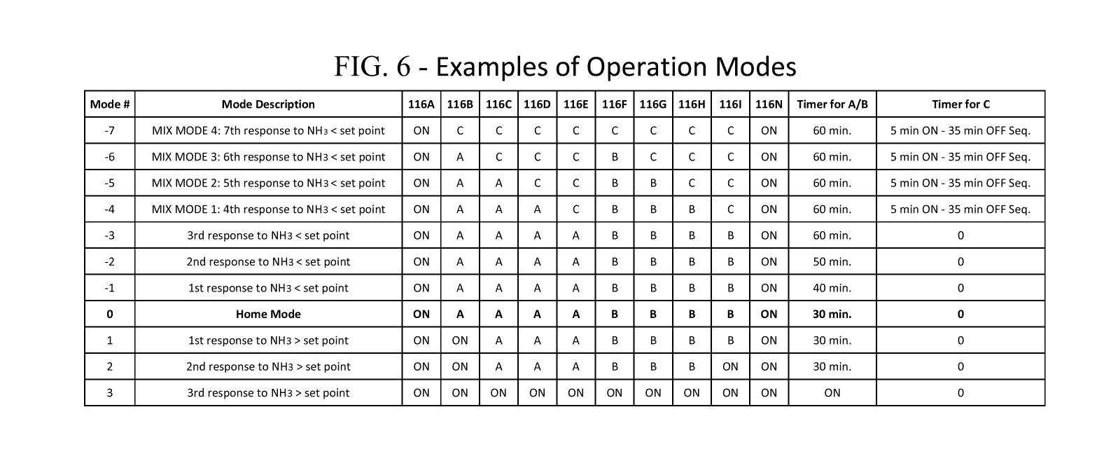

FIG. 5 shows a process of operating a biological wastewater treatment process using a dual-level control system. FIG. 6 shows a table providing an example of the various types of operation modes that may be available for the dual-level control process of FIG. 5.

The operation mode refers to the operation of the aeration chains that bring about the necessary DO content to the various portions of the treatment basin 110 and necessary anoxic and oxic regions in the treatment basins 110. In FIG. 6, the operation mode labels range from −7 to +3; however any suitable labels may be used such as different numerical labels (1-11), alphabetical labels (a-k) or a combination thereof, and any other suitable labels.

The operation mode will determine what aerations chains 116A-116N are operated, when they are operated, and for how long. According to the embodiment of FIGS. 2 and 6, the aeration chain 116A is the aeration chain closest to the inlet 112 of the treatment basin 110 while the aeration chain 116N is the aeration chain closest to the clarifier 136.

According to the embodiment of FIG. 6, depending on the operation mode, an aeration chain may have a status indicated as ON, A, B, or C. The ON status may indicate that the aeration chain is continually in operation. The A status may indicate an aeration chain that is turned on and off for a set period of time according to the A timer (like 60 min, 50 min, 40 min, 30 min, etc.). The B status may indicate an aeration chain that is turned on and off according to the B timer (like 60 min, 50 min, 40 min, 30 min, etc.). The aeration chains are controlled so that the A chains are always on when the B chains are off, and vice versa. The C status (used during the Mixed Mode operation described below) may indicate that the aeration chain is operated according to the C timer, for example, for 5 minutes, and then not operated for 35 minutes, and then repeated constantly thereafter. The Mixed Mode operations may assume, for example, that one C aeration chain may operate at a time and that the C aeration chains will sequentially turn on starting with the aeration chain at the front of the aeration basin. For example, in mode −7, aeration chain 116B would start first, followed by aeration chain 116C, and so forth. Alternative embodiments of the present invention may have a different number of aeration chains (such as 2, 5, 10, 20, or more or any integer therebetween), a different combination of ON, A, B, and C statuses for each operation mode, different ON and OFF sequences and times for each of the ON, A, B, and C statuses, and/or different sequential operations for the C aeration chains.

Referring back to FIG. 5, the dual level control method and system is used in a cascading fashion as follows.

At step S10, the effluent NH₃ concentration at the outlet 114 is measured using the process control variable sensor 132. The measurement signal is sent to the process control variable controller/PLC and is received as an input at step S10 in FIG. 5. The measured effluent NH₃ concentration may be a single point measurement, an average or mean value based on a series of measurements taken over a period of time, or an average or mean value based on a series of different measurements taken by a series of process control variable sensors at a single point or over a period of time (if there is more than one process control variable sensor being used at the outlet 114).

The primary level of control uses the measured effluent NH₃ concentration from step S10 to automatically adjust the DO set point. At step S12, if the process control variable controller/PLC determines that the measured effluent NH₃ concentration is less than or equal to a minimum NH₃ set point, the process will proceed to step S14. The minimum NH₃ set point may be, for example, 0.5 mg/l, but any suitable value may be used such as, for example, 0.05, 0.1, 0.2, 0.5, 0.6, up to 5.0 mg/l or any 0.01 increment therebetween or any value therebetween. If at step S12 the effluent NH₃ concentration is determined to be at or above the maximum NH₃ set point, the process control variable controller/PLC moves the process to step S16. The maximum NH₃ set point may be, for example, 1.0 mg/l, but any suitable value may be used such as 0.1, 0.9, 1.0, 1.1, 1.2, 2.0, up to 10.0 mg/l or any 0.01 increment therebetween or any value therebetween. If at step S12 the effluent NH₃ concentration is between the minimum and maximum NH₃ set points, the process control variable controller/PLC will determine that the DO set point is to remain unchanged and proceed to step S18. That is, there will be no process adjustment of the DO set point if the effluent NH₃ concentration is between the minimum and maximum NH₃ set points. The primary control may be accomplished using a PID control loop, but can be done in other ways.

At step S14, it is determined if the DO set point is equal to or less than the minimum allowable DO set point. This minimum allowable DO set point may be adjustable through an operator interface of the process control variable controller/PLC. For example, the minimum allowable DO set point may be 0.1 mg/l, but any suitable set point may be used such as 0.05, 0.1, 0.2. 0.5, 1 mg/l or any 0.1 increment therebetween or any value therebetween.

If the DO set point is equal to or less than the minimum allowable DO set point, then the secondary level of control proceeds to step S20 where the second level of control will automatically increase the aeration chain timers according to the operation modes in FIG. 6, up to the maximum chain timer value (for example, 60 minutes as shown in operation mode −3) by incrementing the operation mode by −1. This allows more time in one state, which results in more depletion of DO during anoxic times and more time in a deeper anoxic condition, which will improve denitrification. The process then returns back to step S10.

If the measured effluent NH₃ remains less than or equal to the minimum NH₃ set point, the DO set point is at the minimum value or lower, and after a predetermined amount of time (that is, for example, when the process is repeatedly incremented −1 after several iterations of steps S12 and S14), then the process will eventually go into a Mix Mode at step S20 (that is, status C). In the Mix Mode (that is, the current operation mode is one of operation mode −4, −5, −6, or −7), a separate Mix Mode timer (timer C) will be initiated and will control the ON/OFF operation of the aeration chains designated to operate in Mix Mode. During the Mix Mode, an aeration chain is ON for the minimum amount of time per hour needed to mix the basin volume associated with that aeration chain. The Mix Mode timer is adjustable from the operator interface of the process control variable controller/PLC. If the effluent NH₃ remains below the minimum NH₃ set point, an increasing number of aeration chains will be changed to Mix Mode control (C status) until the minimum number of aeration chains are operating so that the smallest blower is operating above its minimum operating point (that is, the operation modes keep decreasing −1). The Mix Mode operation will advance through the aeration chains in the basin until operation mode −7 is reached.

During Mix Mode operation, the Mix Mode operating parameters calls for activation of one or more aeration chains for an amount of time sufficient to mix a volume of wastewater associated with said one or more aeration chains. Besides the values provided in FIG. 6 for Mix Mode operation, other embodiments of the present invention permit that the one or more aeration chains may cycle on for 0.1-20 minutes (or any 0.1 increment therebetween or any value therebetween) and cycles off for 5-150 minutes (or any 0.1 increment therebetween or any value therebetween). Also, the Mix Mode operating parameters may cause a volume of wastewater associated with one or more aeration chains to be in an oxic state for a proportion of time ranging from about 1% to about 100% (or any 0.1 incremental percentage therebetween or any value therebetween). Further, the Mix Mode operating parameters may cause a volume of wastewater associated with one or more aeration chains to be in an anoxic state for a proportion of time ranging from about 99% to about 0% (or any 0.1 incremental percentage therebetween or any value therebetween).

While in the Mix Mode operation, if the effluent NH₃ increases so that it is now equal to or above the maximum NH₃ set point (that is, the process goes from step S12 to S16) and the DO set point is at or above the maximum allowable DO set point, the control system will sequentially back the aeration chain operation out of the Mix Mode operation by incrementing the operation mode +1 according to the operation modes in FIG. 6 until the effluent NH₃ concentration below the maximum NH₃ set point.

If at step S14, the DO set point is not equal to or less than the minimum allowable DO set point (that is, the DO set point is greater than the minimum allowable DO set point), then the secondary level of control proceeds to step S18. At step S18, the DO set point is decreased by, for example, 0.05, although any suitable increment may be determined by the PID loop in the process control variable controller/PLC (such as for example, 0.01, 0.02, 0.04, 0.10, 0.20 or any 0.01 increment therebetween or any value therebetween).

At step S12, if effluent NH₃ concentration is greater than or equal to the maximum NH₃ set point, the process goes to step S16. At step S16, it is determined if the DO set point is equal to or greater than the maximum allowable DO set point. This maximum allowable DO set point may be adjustable through an operator interface of the process control variable controller/PLC. For example, the maximum allowable DO set point may be 3.0 mg/l, but any suitable set point may be used such as 0.5, 1.0 1.5, 2, 3, 4, 5, 6, 7, 8 mg/l, or any 0.1 increment therebetween or any value therebetween.

When the DO set point is at or above the maximum value (that is, YES), then the secondary level of control proceeds to step S22. At step S22, the process will automatically be used to adjust the operation of the aeration chains by incrementing the operation mode by +1. If conditions do not change (that is, the steps of S12 and S16 are repeated), the aeration chains will proceed from Mix Mode operation (for example, operation modes −7 to −4) to automatically and sequentially change from ON/OFF wave oxidation operation (for example, operation modes −3 to 2) and eventually to ON 100% of the time (operation mode 3). In other words, the required change in operation will be determined by the measured DO and NH₃ concentrations, with the system responding according to the operation modes shown in FIG. 6. As long as the process conditions are unchanged, the control system will continue to require operational changes according to FIG. 6 until all the aeration chains are ON 100% of the time at operation mode 3, which is the maximum aeration state of the system. As long as the effluent NH₃ concentration is greater than or equal to the maximum NH₃ set point, the system will remain in this state.

When the DO set point is below the maximum value at step S16 (that is, NO), then the secondary level of control proceeds to step S18. At step S18, the DO set point is increased by 0.05, although any suitable increment may be determined by the PID loop in the process control variable controller/PLC (such as for example, 0.01, 0.02, 0.04, 0.10, 0.20 or any 0.01 increment therebetween or any value therebetween).

At step S24, the DO controller will command the aeration blowers 120, the control valve 122, and the control valves 124 to increase or decrease their air output based on the relationship between the measured DO concentration in the treatment basin 10 from the measurement signal received from the DO sensor 130 and the DO set point received from the process control variable controller/PLC, similar to the control scheme provided in relation to FIG. 1. The measured DO concentration from the DO sensor 130 used for control may be an instantaneous concentration, an average concentration of measurements over time, or an average concentration of measurements performed over a plurality of DO sensors. The process returns to step S10.

FIG. 6 shows an example of the various types of operation modes that may be available for the dual-level control system. During operation of the system and process, several trend may be observed:

(1) A measurement of a concentration of effluent NH₃, which is at or above a maximum value (step S12 to step S16), when combined with a DO set point at or above a maximum value (YES from step S16), triggers an activation of an additional aeration chain as the operation mode is incremented +1.

(2) A measurement of a concentration of effluent NH₃, which is at or below a minimum value (step S12 to step S14), when combined with a DO set point at or below a minimum value (YES from step S14), calls for an increase in an aeration chain timer up to a maximum value as the operation mode is incremented −1 up to operation mode −3.

(3) A measurement of a concentration of effluent NH₃, which is at or below a minimum value (step S12 to step S14), when combined with a DO set point at or below a minimum value (YES from step S14), calls for initiation of Mix Mode operating parameters at operation mode −4 after a predetermined amount of time.

It is noted that the system may have only one, two, three, four, or more blowers. Also, it is noted that any suitable blower may be used and any suitable diffuser may be used.

In accordance with the above system and process described above, according to one embodiment of the present invention in its broadest sense, a method of automatically operating a biological wastewater treatment process within one or more treatment basins 110, each equipped with a plurality of aeration chains 116A-116N, may comprise: automatically measuring a concentration of effluent ammonia (NH₃) at the outlet 114 using a process control variable sensor 132, automatically comparing the measured concentration of effluent NH₃ with a predetermined value in the process control variable controller 134, automatically adjusting a dissolved oxygen (DO) set point based on a deviation, if any, of the measured concentration of effluent NH₃ from the predetermined value (see step S12 to either step S16 or step S14) and automatically adjusting an aeration chain timer and/or an aeration chain grouping based on a deviation, if any, of the measured concentration of effluent NH₃ from the predetermined value. Such a process and method does not include or require automatically measuring a concentration of effluent nitrate (NO₃) or automatically comparing measured concentration of effluent NO₃ with a predetermined value.

The description above uses effluent ammonia (NH₃) as the process control variable for the purposes of illustration, but any of effluent nitrate (NO₃), effluent alkalinity, or effluent oxidation-reduction potential (ORP) may be measured and used as the process control variable. In other words, process control variables other than ammonia (NH₃) can be measured and used for controlling the process. All of these variables will fluctuate with changes within the biological process and can be useful for monitoring and control. In the same way that effluent NH₃ can be measured and used for control, effluent NO₃, effluent alkalinity, and/or effluent ORP can be measured and used for the primary level of control in the dual level control system.

Referring to FIG. 5, if effluent nitrate (NO₃) is the process control variable, the effluent NO₃ concentration at the outlet 114 is measured using the one or more process control variable sensors 132 at step S10. However, at step S12, if the process control variable controller/PLC determines that the measured effluent NO₃ concentration is less than or equal to a minimum NO₃ set point, the process will proceed to step S16 (not step S14). The minimum NO₃ set point may be, for example, 0.5 mg/l, but any suitable value may be used such as, for example, 0.05, 0.1, 0.2, 0.5, 0.6, up to 5.0 mg/l or any 0.01 increment therebetween or any value therebetween. If at step S12 the effluent NO₃ concentration is determined to be at or above the maximum NO₃ set point, the process control variable controller/PLC moves the process to step S14 (not step S16). The maximum NO₃ set point may be, for example, 1.0 mg/l, but any suitable value may be used such as 0.1, 0.9, 1.0, 1.1, 1.2, 2.0, up to 10.0 mg/l or any 0.01 increment therebetween or any value therebetween. If at step S12 the effluent NO₃ concentration is between the minimum and maximum NO₃ set points, the process control variable controller/PLC will determine that the DO set point is to remain unchanged and proceed to step S18. The remaining steps of FIG. 5 will remain the same as in the case of NH₃ being the process control variable.

If effluent ORP is the process control variable, the effluent ORP concentration at the outlet 114 is measured using the one or more process control variable sensors 132 at step S10. However, at step S12, if the process control variable controller/PLC determines that the measured effluent ORP concentration is less than or equal to a minimum ORP set point, the process will proceed to step S16 (not step S14). The minimum ORP set point may be, for example, 0.5 mg/l, but any suitable value may be used such as, for example, 0.05, 0.1, 0.2, 0.5, 0.6, up to 5.0 mg/l or any 0.01 increment therebetween or any value therebetween. If at step S12 the effluent ORP concentration is determined to be at or above the maximum ORP set point, the process control variable controller/PLC moves the process to step S14 (not step S16). The maximum ORP set point may be, for example, 1.0 mg/l, but any suitable value may be used such as 0.1, 0.9, 1.0, 1.1, 1.2, 2.0, up to 10.0 mg/l or any 0.01 increment therebetween or any value therebetween. If at step S12 the effluent ORP concentration is between the minimum and maximum ORP set points, the process control variable controller/PLC will determine that the DO set point is to remain unchanged and proceed to step S18. The remaining steps of FIG. 5 will remain the same as in the case of NH₃ being the process control variable.

If effluent alkalinity is the process control variable, the effluent alkalinity concentration at the outlet 114 is measured using the one or more process control variable sensors 132 at step S10. At step S12, if the process control variable controller/PLC determines that the measured effluent alkalinity concentration is less than or equal to a minimum alkalinity set point, the process will proceed to step S14 (just as for NH₃). The minimum alkalinity set point may be, for example, 0.5 mg/l, but any suitable value may be used such as, for example, 0.05, 0.1, 0.2, 0.5, 0.6, up to 5.0 mg/l or any 0.01 increment therebetween or any value therebetween. If at step S12 the effluent alkalinity concentration is determined to be at or above the maximum alkalinity set point, the process control variable controller/PLC moves the process to step S16 (just as for NH₃). The maximum NH₃ set point may be, for example, 1.0 mg/l, but any suitable value may be used such as 0.1, 0.9, 1.0, 1.1, 1.2, 2.0, up to 10.0 mg/l or any 0.01 increment therebetween or any value therebetween. If at step S12 the effluent alkalinity concentration is between the minimum and maximum alkalinity set points, the process control variable controller/PLC will determine that the DO set point is to remain unchanged and proceed to step S18. The remaining steps of FIG. 5 will remain the same as in the case of NH₃ being the process control variable.

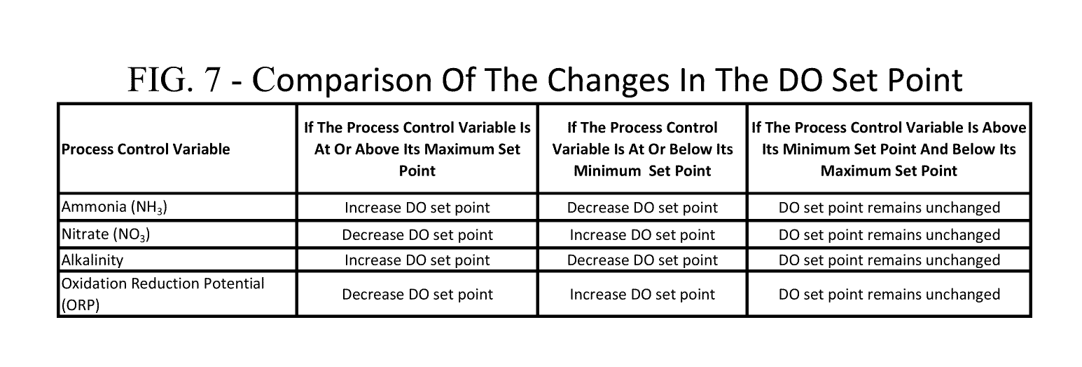

FIG. 7 shows a table providing a comparison of the changes in the DO set point depending on the values of certain process control variables. The table indicates that a measurement of a concentration of effluent NH₃, effluent NO₃, effluent alkalinity, or effluent ORP which falls within a predetermined range of values (below the maximum set point but above the minimum set point), allows the wastewater treatment apparatus to maintain a primary mode of operating parameters (that is, no change in the DO set point). A measurement of a concentration of effluent NH₃ or effluent alkalinity which is at or below a minimum value (minimum set point), may call for a decrease in a DO set point, while a measurement of a concentration of effluent NH₃ or effluent alkalinity, which is at or above a maximum value, may call for an increase in the DO set point. A measurement of a concentration of effluent NO₃ or effluent ORP, which is at or below a minimum value (minimum set point), may call for an increase in a DO set point, while a measurement of a concentration of effluent NO₃ or effluent ORP, which is at or above a maximum value, may call for a decrease in a DO set point. As previously mentioned, a decrease in a DO set point signals a decrease in an output of one or more aeration blowers, while an increase in a DO set point signals an increase in an output of one or more aeration blowers.

The control systems, wastewater treatment apparatuses, and methods like those disclosed herein may provide one or more of the following benefits. First, wastewater treatment plants are dynamically loaded, meaning that the flow and pollutant load to the plant is constantly changing. There are daily variations of the flow and pollutant load depending on the time of day as well as weekly variations from weekdays to weekends, seasonal variations, and even yearly variations as the development of the local community may result in changing demands on the wastewater treatment plant. The control systems, wastewater treatment apparatuses, and methods like those disclosed herein can automatically adjust and optimize its performance in the face of all these changes, which will provide higher quality effluent at the optimum energy usage relative to plants that do not have this capability. Thus, the embodiments of the present invention as described herein provide control systems, wastewater treatment apparatuses, and method that continually adjust the operating parameters to ensure the highest quality effluent at the lowest energy usage.

In particular, nitrification is a rate limiting step in the total nitrogen removal treatment basin 10. Nitrification is an aerobic process. Therefore, using effluent NH₃ concentration (or effluent NO₃ concentration or effluent alkalinity concentration or effluent ORP concentration) to continuously adjust the DO set point as described in the above control systems, wastewater treatment apparatuses, and methods may permit that the minimum amount of oxygen and energy is used to achieve the desired level of nitrification. This is a superior method to reduce energy consumption relative to DO control, as the aeration energy is directly tied to the process result desired (effluent total nitrogen concentration). Energy usage is optimized and only the minimum amount of energy needed to achieve the desired process result is used. For example, the control systems, wastewater treatment apparatuses, and methods like those disclosed herein may result in an energy consumption that is at least 10% lower over a 12-month period compared with the energy consumption of a method of operating a biological wastewater treatment process in which a DO set point, an aeration chain timer and an aeration chain grouping are manually adjusted. Thus, as described herein are control systems, wastewater treatment apparatuses, and methods that provide instantaneous and automatic operational adjustment of the process to ensure that the highest quality water is consistently achieved with the lowest possible energy usage. As the flows and pollutant loads to the treatment plant varies, the system automatically adjusts such that it does not use more aeration and mixing energy than necessary to provide the desired effluent NH₃ concentration and total N concentration.

The control systems, wastewater treatment apparatuses, and methods like those disclosed herein may incorporate direct, online and continuous reading of an effluent process control variable, such as for example, effluent ammonia (NH₃) concentration, effluent NO₃ concentration, effluent alkalinity concentration or effluent ORP concentration. As the purpose of the treatment plant is to remove ammonia and total nitrogen from the wastewater, using effluent ammonia (effluent NO₃ or effluent alkalinity, or effluent ORP) for control directly relates the process control to the plant performance. Doing so improves the quality of the effluent.

Because biological nitrification is the rate limiting step in the process, the control systems, wastewater treatment apparatuses, and methods like those disclosed herein may use a primary level of control where effluent ammonia concentration may be the best online variable to use to continuously adjust the DO set point which in turn dynamically controls the operation of the one or more aeration blowers 120.

Further, the control systems, wastewater treatment apparatuses, and methods like those disclosed herein may use a secondary level of control that uses both the process control variable and the DO concentration to automatically and instantaneously control the amount of oxic time vs. anoxic time and the anoxic volume vs. the oxic volume within the treatment basin 10, 110. This is done by dynamically controlling the operation of the aeration chain equipment 16A-16N within the treatment basin 10, 110.

Because the control systems, wastewater treatment apparatuses, and methods like those disclosed herein may be contained in one long sludge age treatment basin 10, 110 (or there may be multiple parallel treatment basins), the control systems, wastewater treatment apparatuses, and methods like those disclosed herein may automatically adjust the process configuration and volume of the oxic vs. anoxic zones present to maximize the total nitrogen removal at all times. The process is automatically and continuously reconfigured based on the treatment needs at any point in time, from 0% anoxic and 100% oxic, to 99% anoxic and 1% oxic, preferably to 85% anoxic and 15% oxic. Other competitive systems that use separate oxic and anoxic tanks to achieve the total N removal do not have this same degree of process flexibility due to the physical constraints of the various tank sizes. Using one basin (for example, a tank) may provide complete flexibility to use the total system volume as needed based on the process requirements.

The control systems, wastewater treatment apparatuses, and methods like those disclosed herein may optionally include a Mix Mode operation. The one or more process control variable sensors or probes 132 at the outlet 114 may be used to provide the control signal needed to adjust the DO set point to achieve the desired level of nitrification. It also automatically determines when to operate in the Mix Mode using the same logic as discussed above for the total nitrogen removal process. Operating in the Mix Mode results in less air and energy being used by the process, as only enough air to provide the desired effluent total nitrogen is used. As the load to the plant changes and the effluent NH₃ (or effluent ORP or effluent alkalinity or effluent NO₃) increases and decreases, the aeration air and energy usage is automatically optimized based on meeting the desired treatment result. Depending on the load to the plant, the Mix Mode operation can reduce the energy usage by as much as 50% relative to a system without a Mix Mode operation.

Also, a significant use of the Mix Mode operation may be to minimize the energy required to mix the treatment basin 10, 110. Because the whole treatment basin 10, 110 is not continuously aerated, the Mix Mode operation requires much less air and energy for mixing than aerating the entire basin 10, 110. Reducing the energy required to mix the treatment basin 10, 110 allows the basin 10, 110 to operate with lower energy consumption when the load to the system is very low. Depending on the load to the plant, the Mix Mode operation can reduce the energy usage by as much as 50% relative to a system without the Mix Mode operation.

Further, the control systems, wastewater treatment apparatuses, and methods like those disclosed herein may overcome the mixing limitations of other aeration systems. Other aeration systems mix the basin and cannot be operated at an energy level less than the minimum energy required for mixing. This restricts the turndown capability of the aeration systems to approximately 50-60% of the design energy level. It is not possible to use less energy than this, even if the process conditions call for less aeration and less energy. Therefore, energy is wasted and the system is not operating at optimum efficiency. The Mix Mode operation as disclosed herein allows the aeration system to efficiently operate at these low load process conditions using the minimum amount of energy needed to provide the desired effluent NH₃ concentration and total N concentration. The Mix Mode operation automatically changes the system operating strategy and mixes a progressively smaller portion of the basin at a time, resulting in progressively less energy being consumed, while the desired effluent quality is still provided. This operating strategy allows the aeration system to be turned down by 80-90% vs. 50-60% as before. With an average increase in turndown capability of 30%, if the Mix Mode operation is employed 50% of the time, the aeration system energy usage is decreased by 15% relative to systems without Mix Mode.

Besides those embodiments depicted in the figures and described in the above description, other embodiments of the present invention are also contemplated. For example, any single feature of one embodiment of the present invention may be used in any other embodiment of the present invention. For example, a dual-level control system for operating a wastewater treatment apparatus, a wastewater treatment apparatus, and/or a method of automatically operating a biological wastewater treatment process within one or more treatment basins, each equipped with a plurality of aeration chains, may comprise any one or more of the following features (1)-(30) in any combination:

(1) at least a primary level of control including a measurement of a process control variable to arrive at a dissolved oxygen (DO) set point and a primary mode of operating parameters including primary aeration chain timer and primary aeration chain grouping designed to achieve the DO set point when the DO set point falls within a predetermined range of values;

(2) at least a secondary level of control to arrive at a secondary mode of operating parameters including secondary aeration chain timer and secondary aeration chain grouping designed to achieve a desired concentration of effluent total nitrogen when the DO set point either falls to or below a minimum value or rises to or above a maximum value;

(3) the process control variable is a measurement of a concentration of effluent ammonia (NH₃), a concentration of effluent nitrate (NO₃), a concentration of effluent alkalinity, a concentration of effluent oxidation-reduction potential (ORP), or a combination thereof;

(4) the at least primary level of control and at least secondary level of control do not rely on a measurement of a concentration of effluent nitrate (NO₃);

(5) a measurement of a concentration of the process control variable which falls within a predetermined range of values, allows the wastewater treatment apparatus to maintain a primary mode of operating parameters;

(6) a measurement of a concentration of the process control variable, which is at or below a minimum value, calls for a decrease in a DO set point, while a measurement of a concentration of the process control variable, which is at or above a maximum value, calls for an increase in a DO set point;

(7) a decrease in a DO set point signals a decrease in an output of one or more aeration blowers, while an increase in a DO set point signals an increase in an output of one or more aeration blowers;

(8) the process control variable is one of a concentration of effluent ammonia (NH₃) and a concentration of effluent alkalinity;

(9) a measurement of a concentration of the process control variable, which is at or below a minimum value, calls for an increase in a DO set point, while a measurement of a concentration of the process control variable, which is at or above a maximum value, calls for a decrease in a DO set point;

(10) the process control variable is one of a concentration of effluent nitrate (NO₃) and a concentration of effluent oxidation-reduction potential (ORP);

(11) the process control variable is effluent NH₃, and wherein a measurement of a concentration of effluent NH₃, which is at or above a maximum value, when combined with a DO set point at or above a maximum value, triggers an activation of an additional aeration chain;

(12) the process control variable is effluent NH₃, and wherein a measurement of a concentration of effluent NH₃, which is at or below a minimum value, when combined with a DO set point at or below a minimum value, calls for an increase in an aeration chain timer up to a maximum value;

(13) the process control variable is effluent NH₃, and wherein a measurement of a concentration of effluent NH₃, which is at or below a minimum value, when combined with a DO set point at or below a minimum value, calls for initiation of mix mode operating parameters after a predetermined amount of time;

(14) mix mode operating parameters calls for activation of one or more aeration chains for an amount of time sufficient to mix a volume of wastewater associated with said one or more aeration chains;

(15) said one or more aeration chains cycles on for 0.1-20 minutes and cycles off for 5-150 minutes;

(16) mix mode operating parameters causes a volume of wastewater associated with one or more aeration chains to be in an oxic state for a proportion of time ranging from about 1% to about 100%;

(17) mix mode operating parameters causes a volume of wastewater associated with one or more aeration chains to be in an anoxic state for a proportion of time ranging from about 99% to about 0%;

(18) mix mode operating parameters minimizes an amount of energy needed to provide the desired concentration of effluent total nitrogen such that the system is configured to turn down to as little as about 80% during low pollutant load conditions;

(19) the control system is configured to provide instantaneous and automatic operational adjustment of aeration based on the primary and second levels of control so as to ensure that the desired concentration of effluent total nitrogen is consistently achieved while minimizing energy usage;

(20) one or more treatment basins, each configured to accept influent and to release effluent and equipped with a plurality of aeration chains, one or more aeration blowers, one or more sensors to measure dissolved oxygen (DO) in the basin, one or more sensors to measure at least one process control variable, and one or more control features for automatically adjusting DO set point, aeration chain timer and aeration chain grouping;

(21) the at least one process control variable is one of a concentration of effluent ammonia (NH₃), a concentration of effluent nitrate (NO₃), a concentration of effluent alkalinity, a concentration of effluent oxidation-reduction potential (ORP), or a combination thereof;

(22) the one or more treatment basins are not equipped with a sensor to measure a concentration of effluent nitrate (NO₃);

(23) the one or more control features is configured to automatically and continuously adjust the configuration and volume of oxic and anoxic zones present in the one or more treatment basins so as to achieve a desired concentration of effluent total nitrogen continuously;

(24) the one or more control features is configured to automatically and continuously adjust the configuration and volume of oxic and anoxic zones present in the one or more treatment basins such that the configuration and volume of oxic and anoxic zones range from 0% anoxic and 100% oxic to 99% anoxic and 1% oxic;

(25) automatically measuring a process control variable;

(26) automatically comparing the measured process control variable with a predetermined value;

(27) automatically adjusting a dissolved oxygen (DO) set point based on a deviation, if any, of the measured process control variable from the predetermined value;

(28) automatically adjusting an aeration chain timer and/or an aeration chain grouping based on a deviation, if any, of the measured process control variable from the predetermined value;

(29) automatically measuring a concentration of effluent nitrate (NO₃) or automatically comparing measured concentration of effluent NO₃ with a predetermined value is not included; and

(30) energy consumption is at least 10% lower over a 12-month period compared with the energy consumption of a method of operating a biological wastewater treatment process in which a DO set point, an aeration chain timer and an aeration chain grouping are manually adjusted.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A dual-level control system for operating a wastewater treatment apparatus comprising:
at least a primary level of control including a measurement of a process control variable to arrive at a dissolved oxygen (DO) set point and a primary mode of operating parameters including primary aeration chain timer and primary aeration chain grouping designed to achieve the DO set point when the DO set point falls within a predetermined range of values; and
at least a secondary level of control to arrive at a secondary mode of operating parameters including secondary aeration chain timer and secondary aeration chain grouping designed to achieve a desired concentration of effluent total nitrogen when the DO set point either falls to or below a minimum value or rises to or above a maximum value.

2. The dual-level control system of claim 1 in which the process control variable is a measurement of a concentration of effluent ammonia (NH₃), a concentration of effluent nitrate (NO₃), a concentration of effluent alkalinity, a concentration of effluent oxidation-reduction potential (ORP), or a combination thereof.

3. The dual-level control system of claim 1 in which the at least primary level of control and at least secondary level of control do not rely on a measurement of a concentration of effluent nitrate (NO₃).

4. The dual-level control system of claim 1 in which a measurement of a concentration of the process control variable which falls within a predetermined range of values, allows the wastewater treatment apparatus to maintain a primary mode of operating parameters.

5. The dual-level control system of claim 1 in which a measurement of a concentration of the process control variable, which is at or below a minimum value, calls for a decrease in a DO set point, while a measurement of a concentration of the process control variable, which is at or above a maximum value, calls for an increase in a DO set point.

6. The dual-level control system of claim 5 in which a decrease in a DO set point signals a decrease in an output of one or more aeration blowers, while an increase in a DO set point signals an increase in an output of one or more aeration blowers.

7. The dual-level control system of claim 5 in which the process control variable is one of a concentration of effluent ammonia (NH₃) and a concentration of effluent alkalinity.

8. The dual-level control system of claim 1 in which a measurement of a concentration of the process control variable, which is at or below a minimum value, calls for an increase in a DO set point, while a measurement of a concentration of the process control variable, which is at or above a maximum value, calls for a decrease in a DO set point.

9. The dual-level control system of claim 8 in which the process control variable is one of a concentration of effluent nitrate (NO₃) and a concentration of effluent oxidation-reduction potential (ORP).

10. The dual-level control system of claim 1 in which the process control variable is effluent NH₃, and wherein a measurement of a concentration of effluent NH₃, which is at or above a maximum value, when combined with a DO set point at or above a maximum value, triggers an activation of an additional aeration chain.

11. The dual-level control system of claim 1 in which the process control variable is effluent NH₃, and wherein a measurement of a concentration of effluent NH₃, which is at or below a minimum value, when combined with a DO set point at or below a minimum value, calls for an increase in an aeration chain timer up to a maximum value.

12. The dual-level control system of claim 1 in which the process control variable is effluent NH₃, and wherein a measurement of a concentration of effluent NH₃, which is at or below a minimum value, when combined with a DO set point at or below a minimum value, calls for initiation of mix mode operating parameters after a predetermined amount of time.

13. The dual-level control system of claim 12 in which mix mode operating parameters calls for activation of one or more aeration chains for an amount of time sufficient to mix a volume of wastewater associated with said one or more aeration chains.

14. The dual-level control system of claim 13 in which said one or more aeration chains cycles on for 0.1-20 minutes and cycles off for 5-150 minutes.

15. The dual-level control system of claim 12 in which mix mode operating parameters causes a volume of wastewater associated with one or more aeration chains to be in an oxic state for a proportion of time ranging from about 1% to about 100%.

16. The dual-level control system of claim 15 in which mix mode operating parameters causes a volume of wastewater associated with one or more aeration chains to be in an anoxic state for a proportion of time ranging from about 99% to about 0%.

17. The dual-level control system of claim 12 in which mix mode operating parameters minimizes an amount of energy needed to provide the desired concentration of effluent total nitrogen such that the system is configured to turn down to as little as about 80% during low pollutant load conditions.

18. The dual-level control system of claim 1 in which the control system is configured to provide instantaneous and automatic operational adjustment of aeration based on the primary and second levels of control so as to ensure that the desired concentration of effluent total nitrogen is consistently achieved while minimizing energy usage.

19. A wastewater treatment apparatus comprising:
one or more treatment basins, each configured to accept influent and to release effluent and equipped with
a plurality of aeration chains,
one or more aeration blowers,
one or more sensors to measure dissolved oxygen (DO) in the basin,
one or more sensors to measure at least one process control variable, and
one or more control features for automatically adjusting DO set point, aeration chain timer and aeration chain grouping.

20. The wastewater treatment apparatus of claim 19 in which the at least one process control variable is one of a concentration of effluent ammonia (NH₃), a concentration of effluent nitrate (NO₃), a concentration of effluent alkalinity, a concentration of effluent oxidation-reduction potential (ORP), or a combination thereof.

21. The wastewater treatment apparatus of claim 19 in which the one or more treatment basins are not equipped with a sensor to measure a concentration of effluent nitrate (NO₃).

22. The wastewater treatment apparatus of claim 19 in which the one or more control features is configured to automatically and continuously adjust the configuration and volume of oxic and anoxic zones present in the one or more treatment basins so as to achieve a desired concentration of effluent total nitrogen continuously.

23. The wastewater treatment apparatus of claim 19 in which the one or more control features is configured to automatically and continuously adjust the configuration and volume of oxic and anoxic zones present in the one or more treatment basins such that the configuration and volume of oxic and anoxic zones range from 0% anoxic and 100% oxic to 99% anoxic and 1% oxic.

24. A method of automatically operating a biological wastewater treatment process within one or more treatment basins, each equipped with a plurality of aeration chains, comprising:
automatically measuring a process control variable,
automatically comparing the measured process control variable with a predetermined value,
automatically adjusting a dissolved oxygen (DO) set point based on a deviation, if any, of the measured process control variable from the predetermined value and
automatically adjusting an aeration chain timer and/or an aeration chain grouping based on a deviation, if any, of the measured process control variable from the predetermined value.

25. The method of claim 24 which does not include automatically measuring a concentration of effluent nitrate (NO₃) or automatically comparing measured concentration of effluent NO₃ with a predetermined value.

26. The method of claim 24 whose energy consumption is at least 10% lower over a 12-month period compared with the energy consumption of a method of operating a biological wastewater treatment process in which a DO set point, an aeration chain timer and an aeration chain grouping are manually adjusted.

27. The method of claim 24 in which the process control variable is one of a concentration of effluent ammonia (NH₃), a concentration of effluent nitrate (NO₃), a concentration of effluent alkalinity, a concentration of effluent oxidation-reduction potential (ORP), or a combination thereof.
